(19) United States
(12) Patent Application Publication
(10) Pub. No.: US 2014/0347537 A1
(43) Pub. Date: Nov. 27, 2014

(54) IMAGING SENSOR CAPABLE OF PHASE DIFFERENCE FOCUS DETECTION

(71) Applicant: SAMSUNG ELECTRONICS CO., LTD., Suwon-si (KR)

(72) Inventor: Masataka Hamada, Suwon-si (KR)

(73) Assignee: SAMSUNG ELECTRONICS CO., LTD., Suwon-si (KR)

(21) Appl. No.: 14/279,638

(22) Filed: May 16, 2014

(30) Foreign Application Priority Data
May 24, 2013 (KR) 10-2013-0059261

(51) Int. Cl. H04N 5/232; H04N 5/3745

(52) U.S. Cl. CPC H04N 5/23212; H04N 5/3745
USPC 348/308

(57) ABSTRACT

An imaging device capable of phase difference focus detection is described. The imaging device includes a plurality of pixels that are 2-dimensionally arranged and which receive image light. At least one pixel of the plurality of pixels comprises: a micro lens; a plurality of photoelectric conversion units, which are biased around an optical axis of the micro lens; and a control unit, which limits generation of electrons photoelectrically converted at at least one photoelectric conversion unit of the plurality of photoelectric conversion units.

### CROSS-REFERENCE TO RELATED PATENT APPLICATION

This application claims the priority benefit of Korean Patent Application No. 10-2013-0059261, filed on May 24, 2013, in the Korean Intellectual Property Office, the disclosure of which is incorporated by reference herein in its entirety.

### BACKGROUND

1. Technical Field

The present disclosure relates to an imaging sensor, and more particularly, to an imaging sensor capable of detecting a phase difference of focus.

2. Related Art

In a digital photographing apparatus, such as a camera or a camcorder, it is desirable to precisely set focus on an object to capture a clear still image or a clear moving picture. Examples of auto focus (AF) adjusting mechanisms for automatically adjusting focus include a contrast AF and a phase difference AF.

The contrast AF is a mechanism for acquiring contrast values with respect to image signals that are generated by an imaging sensor while position of a focus lens is being changed and moving the focus lens to a position corresponding to the peak contrast value.

The phase difference AF is a mechanism that employs a separate sensing device and detects a focal point based on phase difference of lights applied to the sensing device.

The phase difference AF is generally faster and more precise than the contrast AF. However, the phase difference AF requires a mirror for detecting a focal point, thereby increasing a size of a photographing device employing the phase difference AF. Furthermore, it may be difficult to detect a focal point while images are successively being captured.

Therefore, to resolve the problem, a method of performing phase difference AF without a mirror by arranging phase difference detecting pixels capable of performing phase difference AF at an imaging sensor has been introduced.

However, outputs of phase difference pixels arranged between imaging pixels significantly differ from those of the remaining pixels. Therefore, the phase difference pixels are considered as defective pixels in an output image and causes deterioration of captured images. The same problem may occur even if phase difference detecting pixels are used as imaging pixels.

### SUMMARY

Various embodiments include an imaging device capable of phase difference focus detection, in which phase difference detecting pixels may be used as imaging pixels, wherein the phase difference detecting pixels are capable of detecting phase difference and capturing an image without deterioration of image quality.

Embodiments also include an imaging device capable of phase difference focus detection, in which pixels may be switched between phase difference detecting pixels and imaging pixels.

Embodiments also include an imaging device capable of phase difference focus detection, in which charge output of a photo diode or a photo transistor is limited or charge generation at a photoelectric conversion unit is limited when pixels are switched between phase difference detecting pixels and imaging pixels.

In an embodiment, an imaging device includes a plurality of pixels that are 2-dimensionally arranged and which receive image light. At least one pixel of the plurality of pixels includes: a micro lens; a plurality of photoelectric conversion units, which are biased around an optical axis of the micro lens; and a control unit, which limits generation of electrons photoelectrically converted at at least one photoelectric conversion unit of the plurality of photoelectric conversion units.

The plurality of photoelectric conversion units may include a plurality of photo diodes. The control unit may limit generation of photoelectrically converted electrons by changing electric potential of at least one photo diode of the plurality of photo diodes.

The plurality of photoelectric conversion units may include a plurality of photo transistors. The control unit may limit generation of photoelectrically converted electrons by changing a gate electric potential of an electron generating unit of at least one photo transistor of the plurality of photo transistors.

The plurality of photoelectric conversion units may include a plurality of photo diodes. The control unit may include a reset unit for discharging electrons generated by the photo diodes and may limit generation of photoelectrically converted electrons by discharging electrons generated by at least one photo diode of the plurality of photo diodes.

The reset unit may include a reset circuit for discharging electrons. The reset unit may be independent from an output unit.

At least one pixel, of the plurality of pixels, that includes the plurality of photoelectric conversion units may be arranged only at a particular region of the imaging device.

From the pixels arranged only at the particular region, pixels of which the photoelectric conversion units are biased in a same direction may be arranged in the same direction as the direction in which the corresponding photoelectric conversion units are biased.

Pixels of the plurality of pixels that include photoelectric conversion units biased in a horizontal direction may be arranged at the imaging device in the horizontal direction.

Pixels of the plurality of pixels that include photoelectric conversion units biased in a vertical direction may be arranged at the imaging device in the vertical direction.

Each pixel of the plurality of pixels included in the imaging device may include a respective plurality of the photoelectric conversion units.

The plurality of pixels, each of which includes the respective plurality of photoelectric conversion units, includes the plurality of photoelectric conversion units biased in a horizontal direction and a vertical direction.

According to another embodiment, an imaging device includes a plurality of pixels that are 2-dimensionally arranged and which receive image light. At least one pixel of the plurality of pixels includes: a micro lens; a plurality of photoelectric conversion units, which are biased around an optical axis of the micro lens; and a control unit, which selects a first output mode for outputting electrons photoelectrically converted at the plurality of photoelectric conversion units or a second output mode for outputting only electrons photoelectrically converted at one of the plurality of photoelectric conversion units. Generation of electrons photoelectrically converted at at least one photoelectric conversion unit is limited in the second output mode.

The control unit may select the first output mode for an imaging operation. The control unit may select the second output mode for a phase difference focusing operation.

Electrons photoelectrically converted at the plurality of photoelectric conversion units may be combined and output in the first output mode.

The at least one pixel may further include a read-out unit which outputs electrons photoelectrically converted at the plurality of photoelectric conversion units.

The read-out unit may include a plurality of read-out transistors for selectively outputting the photoelectrically converted electrons from the plurality of photoelectric conversion units.

Only electrons photoelectrically converted at one photoelectric conversion unit of the plurality of photoelectric conversion units may be output by selectively operating the plurality of read-out transistors in the second output mode.

The at least one pixel that includes the plurality of photoelectric conversion units may be arranged only at a particular region of the imaging device.

From the at least one pixel arranged only at the particular region, pixels of which the plurality of photoelectric conversion units are biased in a same direction are arranged in the same direction as the direction in which the corresponding photoelectric conversion units are biased.

The at least one pixel that includes the plurality of photoelectric conversion units is arranged at the imaging device in a horizontal direction and a vertical direction. The control unit may select the second output mode for the pixels arranged in the horizontal direction when the pixels arranged in the vertical direction correspond to the first output mode. The control unit may select the second output mode for the pixels arranged in the vertical direction when the pixels arranged in the horizontal direction correspond to the first output mode.

Pixels at points where the pixels arranged in the horizontal direction and the pixels arranged in the vertical direction intersect may include a plurality of photoelectric conversion units biased in the horizontal direction and the vertical direction.

Each pixel of the plurality of pixels included in the imaging device may include the plurality of photoelectric conversion units. The plurality of pixels, each of which includes a respective plurality of photoelectric conversion units, may include the plurality of photoelectric conversion units biased in a horizontal direction and a vertical direction.

### BRIEF DESCRIPTION OF THE DRAWINGS

The above and other embodiments of the present disclosure will become more apparent by describing in detail various embodiments thereof with reference to the attached drawings in which:

FIG. 1 is a block diagram illustrating a configuration of an electronic apparatus including an imaging device according to an embodiment;

FIG. 2 is a diagram illustrating a mechanism of a phase difference detecting pixel using the imaging device of FIG. 1;

FIG. 3 is a diagram illustrating a vertical pixel configuration of a phase difference detecting pixel according to an embodiment;

FIG. 4 is a diagram illustrating an equivalent circuit in which a photoelectric conversion unit that implements a phase difference detecting pixel includes two photo diodes, according to an embodiment;

FIG. 5 is a diagram illustrating an equivalent circuit in which a photoelectric conversion unit that implements a phase difference detecting pixel includes two photo diodes and reset circuits that are added to the respective photo diodes, according to an embodiment;

FIG. 6 is a diagram illustrating an equivalent circuit in which a photoelectric conversion unit that implements a phase difference detecting pixel includes two photo transistors, according to another embodiment;

FIG. 7 is a diagram illustrating an equivalent circuit in which a photoelectric conversion unit that implements a phase difference detecting pixel includes two photo transistors and independent transmission transistors are added to the respective photo transistors, according to another embodiment;

FIG. 8 is a diagram illustrating an equivalent circuit in which a photoelectric conversion unit that implements a phase difference detecting circuit includes two photo transistors, according to an embodiment;

FIG. 9 is a diagram illustrating an equivalent circuit in which a photoelectric conversion unit that implements a phase difference detecting pixel includes two photo diodes according to another embodiment;

FIG. 10 is a schematic diagram illustrating a photo transistor for controlling a gate of an N-type substrate according to an embodiment;

FIG. 11 is a schematic diagram illustrating a photo transistor for controlling a gate of an N-type substrate, according to an embodiment;

FIG. 12 is a schematic diagram illustrating a photo transistor for controlling a gate of an N-type substrate, according to an embodiment;

FIG. 13 is a schematic diagram illustrating a pixel which includes a plurality of photoelectric conversion units according to an embodiment, where each of the plurality of photoelectric conversion units includes a photo diode including a P-type substrate;

FIG. 14 is a schematic diagram illustrating a circuit of an imaging device capable of focusing via phase difference detection, according to an embodiment, where a pixel including a plurality of photoelectric conversion units is viewed from above;

FIG. 15 is a schematic diagram illustrating a circuit configuration of an imaging device according to an embodiment;

FIG. 16 is a schematic diagram illustrating a circuit of an imaging device capable of focusing via phase difference detection, illustrating the equivalent circuit shown in FIG. 4A in closer detail;

FIG. 17 is a schematic diagram illustrating a circuit of an imaging device capable of focusing via phase difference detection, according to an embodiment;

FIG. 18 is a plan view illustrating a circuit of an imaging device according to an embodiment;

FIG. 19 is a plan view illustrating an imaging device circuit for phase difference auto focus according to an embodiment;

FIG. 20 is a plan view illustrating a circuit configuration of an imaging device capable of focusing via phase difference detection, according to an embodiment;

FIG. 21 is a plan view illustrating an example of phase difference detecting pixel arrangements in an imaging device capable of focusing via phase difference detection;

FIG. 22 is a plan view illustrating an example of phase difference detecting pixel arrangements in an imaging device capable of focusing via phase difference detection;

FIG. 23 is a plan view illustrating an example of phase difference detecting pixel arrangements in an imaging device capable of focusing via phase difference detection;

FIG. 24 is a flowchart illustrating a sequence of operating an apparatus including an imaging device capable of focusing via phase difference detection according to an embodiment; and

FIG. 25 is a diagram illustrating a vertical pixel configuration of a phase difference detecting pixel of the prior art.

### DETAILED DESCRIPTION

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

While such terms as “first,” “second,” etc., may be used to describe various components, such components must not be limited to the above terms. The above terms are used only to distinguish one component from another.

The terms used in the present specification are merely used to describe particular embodiments, and are not intended to limit the invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Various embodiments will be described below in more detail with reference to the accompanying drawings. Those components that are the same or are in correspondence are rendered the same reference numeral regardless of the figure number, and redundant explanations are omitted. As used herein, the term “and/or” includes any and all combinations of one or more of the associated listed items.

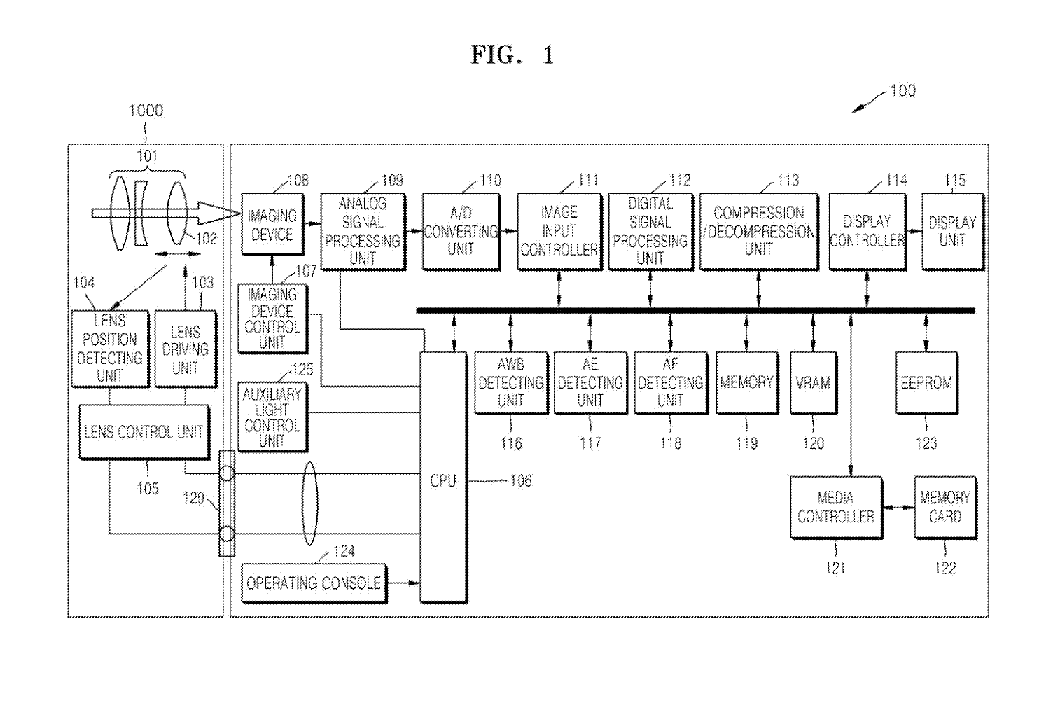

FIG. 1 is a block diagram illustrating a configuration of an electronic apparatus 100, (e.g., digital image processing apparatus, digital camera, camcorder, or other electronic apparatuses having image capturing capabilities) including an imaging device 108 according to an embodiment.

Referring to FIG. 1, the electronic apparatus 100 and a lens 1000 are shown as detachable, the imaging device 108 may also be integrated with the electronic apparatus 100. Furthermore, the electronic apparatus 100 becomes capable of performing both phase difference auto focus (AF) and contrast AF by using the imaging device 108.

The lens 1000 of the electronic apparatus 100 includes an imaging lens 101 including a focus lens 102. The electronic apparatus 100 may perform a focus detecting function for driving the focus lens 102. The lens 1000 includes a lens driving unit 103 for driving the focus lens 102, a lens position detecting unit 104 for detecting position of the focus lens 102, and a lens control unit 105 for controlling the focus lens 102. The lens control unit 105 exchanges information regarding focus detection with a CPU 106 of the electronic apparatus 100 via an interface 129.

The electronic apparatus 100 includes an imaging device 108 and generates image signals by capturing light from an object transmitted through the imaging lens 101. The imaging device 108 may include a plurality of photoelectric conversion units (not shown) and a transmission path (not shown) for reading out image signals by moving electrons from the photoelectric conversion units.

The imaging device control unit 107 generates timing signals for the imaging device 108 to capture images. Furthermore, the imaging device control unit 107 sequentially reads out image signals after electrons are accumulated at respective scan lines.

The read out image signals are converted to digital signals by the analog signal processing unit 109 and the analog-to-digital (A/D) converting unit 110 and are input to an image input controller 111 and processed thereby.

Digital image signals that are input to the image input controller 111 are processed by an auto white balance (AWB) detecting unit 116, an auto exposure (AE) detecting unit 117, and an AF detecting unit 118 for AWB calculation, AE calculation, and AF calculation, respectively. Here, the AF detecting unit 118 outputs detected values regarding contrast values during contrast AF and outputs pixel information to the CPU 106 for phase difference calculation during phase difference AF. The CPU 106 may perform phase difference calculation by performing correlation of a plurality of pixel column signals. As a result, a position of focus or a direction of focus may be calculated.

Image signals are also stored in a synchronous dynamic random access memory (SDRAM) or memory 119. A digital signal processing unit 112 generates displayable live view images or captured images by performing a series of image signal processes, such as gamma correction. A compression/decompression unit 113 compresses image signals or decompresses compressed image signals for playback according to compression formats, such as JPEG compression format or H.264 compression format. An image file including image signals compressed by the compression/decompression unit 113 may be transmitted to a memory card 122 via a memory controller 121 and is stored in the memory card 122. Data regarding images to be displayed is stored in a video random access memory (VRAM) 120, and the images to be displayed are displayed on a liquid crystal display (LCD) or other display unit 115 via a display controller 114. The CPU 106 controls the overall operations of one or more of the components stated above. An electrically erasable programmable read-only memory (EEPROM) 123 stores and maintains data for correcting pixel defects of the imaging device 108 or adjustment data. An operating console 124 receives inputs of various commands from a user for operating the electronic apparatus 100. The operating console 124 may include various buttons, such as a shutter release button, a main button, a mode dial, and a menu button. The electronic apparatus 100 may also include an auxiliary light control unit 125.

FIG. 2 is a diagram illustrating one example of a mechanism of a phase difference detecting pixel using the imaging device 108 of FIG. 1.

Light from an object transmitted through the imaging lens 101 passes through a micro lens array 14 and is guided to light receiving pixels R 15 and L 16. Light screens 17 and 18 or limited apertures for limiting pupils 12 and 13 from the imaging lens 101 are arranged at portions of the light receiving pixels R 15 and L 16. Furthermore, light from the pupil 12 above the optical axis 10 of the imaging lens 101 is guided to the light receiving pixel L 16, whereas light from the pupil 13 below the optical axis 10 of the imaging lens 101 is guided to the light receiving pixel R 15. Guiding lights inversely projected at the pupils 12 and 13 by the micro lens array 14 to the light receiving pixels R 15 and L 16 is referred to as pupil division.

Continuous output of the light receiving pixels R 15 and L 16 by pupil division by the micro lens array 14 exhibits a same shape, but exhibits different phases with respect to position. The reason thereof is that image formation positions of light from the eccentrically formed pupils 12 and 13 of the imaging lens 101 are different from each other. Thus, when focus points of light from the eccentrically formed pupils 12 and 13 are inconsistent with each other, the light receiving pixels R 15 and L 16 exhibit different output phases. On the other hand, when focus points of light from the eccentric pupils 12 and 13 are consistent with each other, images are formed at a same position. In addition, a direction of focus may be determined from the focus difference.

For example, in a front focus state, the phase of the output of the light receiving pixel R 15 is shifted further to the left than that in a focused phase, and the phase of the output of the light receiving pixel L 16 is shifted further to the right than that in the focused phase. In contrast, a back-focusing indicates that an object is in a back focus state. In this case, the phase of the output of the light receiving pixel R 15 is shifted further to the right than that in the focused phase, and the phase of the output of the light receiving pixel L 16 is shifted further to the left than that in the focused phase. The shift amount between the phases of the light receiving pixels R 15 and L 16 may be converted to a deviation amount between the focuses.

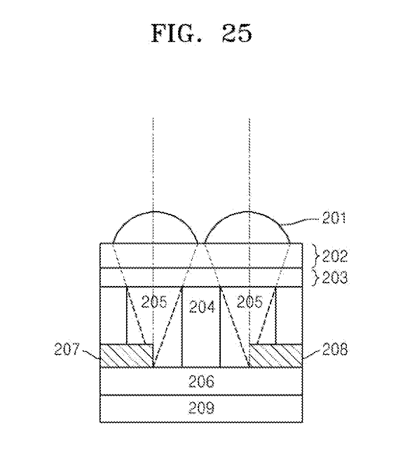

FIG. 25 shows a vertical pixel configuration of a phase difference detecting pixel of the prior art. For convenience of explanation, FIG. 25 shows that a R column pixel and a L column pixel are arranged adjacent to each other. Referring to FIG. 25, a micro lens 201, a surface layer 202, a color filter layer 203, a wiring layer 204, photo diode layers 205 and 206, and a substrate layer 209 are shown. The structure shown in FIG. 25 is illustrated to be more simplified than an actual layer structure. Light from an object passes through the micro lens 201 and arrives at the photo diode layers of each pixel. As light is received, electrons are generated by a photo diode, and the electrons become pixel information. The electrons generated by the photo diode may be output by the wiring layer 204. Light incident from an object is the entire light flux passed through an exit pupil of an imaging lens, and brightness information regarding locations of the object may be acquired based on locations of pixels. The color filter layer 203 generally employs three colors including red (R), green (G), and blue (B). In other embodiments, the color filter layer 203 may employ three colors including cyan (C), magenta (M), and yellow (Y). Next, a light blocking film is arranged at an aperture of an imaging device to acquired signals from the R column and the L column. The structure may include the photo diode layers 205 and 206, a R column light blocking film 207, and a L column light blocking film 208. However, locations of light blocking films are not limited to those shown in FIG. 25, and light blocking layers may be located at any of various locations between a lens and a photo diode.

However, in the above-stated structure of FIG. 25, a pixel difference detecting pixel is fixed in an imaging device once manufactured, and thus the phase difference detecting pixel becomes a defect pixel when an image is captured. Furthermore, phase difference detecting pixels not used during AF also become defect pixels. Defect pixels deteriorate quality of a captured image.

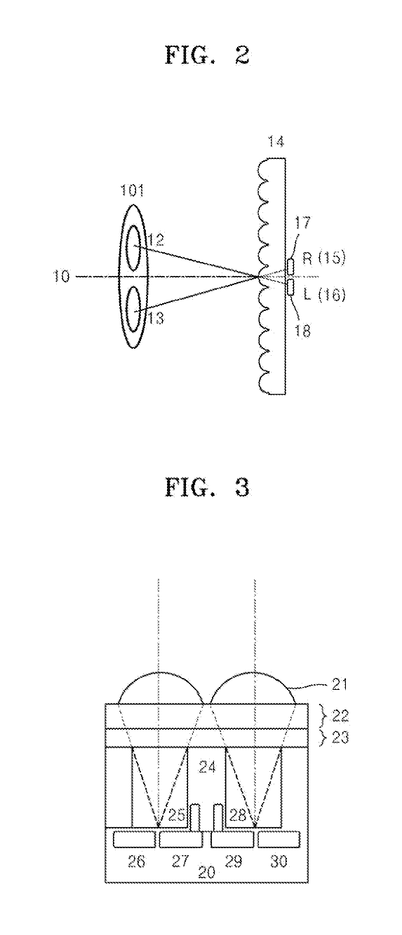

FIG. 3 illustrates a vertical pixel configuration of a phase difference detecting pixel according to an embodiment. FIG. 3 shows a micro-lens 21, a surface layer 22, a color filter layer 23, a wiring layer 24, photoelectric conversion layers 25, 26, and 27, and 28, 29, and 30, and a substrate layer 20 from above in the order stated. One difference between the structure shown in FIG. 3 and the structure shown in FIG. 25 is the photoelectric conversion layers 25, 26, 27, 28, 29, and 30. As shown in FIG. 3, a photoelectric conversion unit may be divided into two at each pixel. The photoelectric conversion unit may include a photo diode or a photo transistor. Furthermore, if used as a phase difference detecting pixel, to activate an R column pixel, a right set 25 and 27 of a first portion of the divided photoelectric conversion unit may be turned on and a left set 25 and 26 of the first portion of the divided photoelectric conversion unit may be turned off. On the contrary, to activate an L column pixel, a left set 28 and 29 of a second portion of the divided photoelectric conversion unit may be turned on and a right set 28 and 30 of the second portion of the divided photoelectric conversion unit may be turned off. Positions of the L column pixel and the R column pixel may be reversed, and if both the R column pixel and the L column pixel are turned on, the phase difference detecting pixel may also be used as an imaging pixel. Here, the turning on and the turning off may be switched at a photoelectric conversion unit, or, as described below, at a read-out line of a photoelectric conversion unit according to an embodiment.

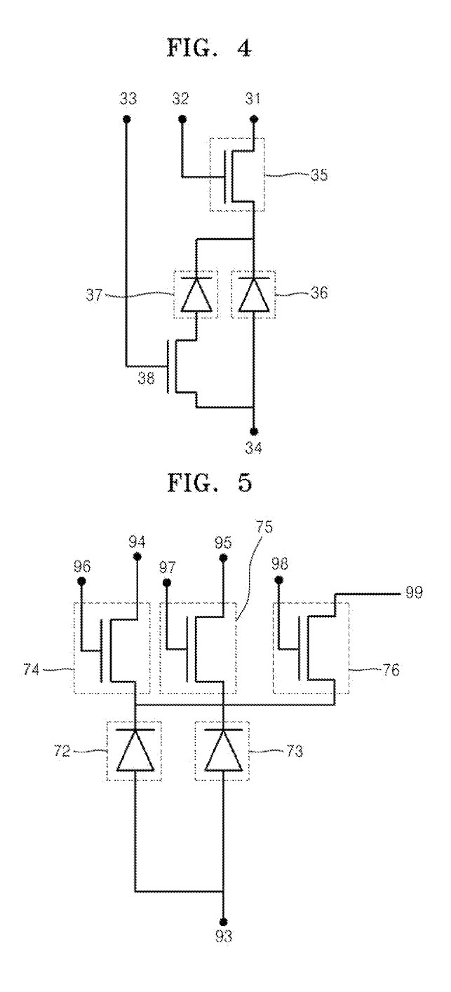

FIG. 4 is a diagram illustrating an equivalent circuit in which a photoelectric conversion unit that implements a phase difference detecting pixel includes two photo diodes, according to an embodiment.

Referring to FIG. 4, a source electrode of read-out metal oxide semiconductor (MOS) transistor 35 is connected to cathodes of photo diodes 36 and 37. A read-out timing line 32 is connected to a gate electrode of the read-out MOS transistor 35. A line 31 connected to a drain electrode of the read-out MOS transistor 35 may be connected to an amplification transistor or a reset transistor. A line 34 having a predetermined electric potential is connected to an anode of the photo diode 36. A switching MOS transistor 38 is connected to an anode of the other photo diode 37. In the above-stated embodiment, the switching MOS transistor 38 is a switch for turning output of the photo diode 37 on and off. However, according to an embodiment, the switching MOS transistor 38 may be replaced by other components not as a switch, but for interfering with generation of electrons at the photo diode 37 (e.g., to prevent or reduce generation of electrons). A gate electrode of the switching MOS transistor 38 may be connected to a phase difference detecting pixel control line 33.

FIG. 5 is a diagram illustrating an equivalent circuit in which a photoelectric conversion unit that implements a phase difference detecting pixel includes two photo diodes and reset circuits that are added to the respective photo diodes, according to another embodiment.

Referring to FIG. 5, a source electrode of a read-out MOS transistor 76 is connected to cathodes of the photo diode 72 and the photo diode 73. A read-out timing line 98 is connected to a gate electrode of the read-out MOS transistor 76. Photoelectric conversion units of the photo diodes 72 and 73 are connected to reset transistors 74 and 75, respectively. A line 93 having a predetermined electric potential is connected to anodes of the photo diodes 72 and 73. A line 99 connected to a drain electrode of the read-out MOS transistor 76 provides an output terminal. The reset transistors 74 and 75 may be used not only for resetting electrons, but also discharging electrons generated by photoelectric conversion units in real time. For example, by turning on terminals 96 and 97 connected to gate electrodes of the reset transistors 74 and 75, electrons of one of the photo diode 72 or the photo diode 73 are discharged via lines 94 and 95, and thus electrons are not accumulated. As a result, only electrons of the other one of the photo diode 72 or the photo diode 73 are accumulated. Therefore, output of only one of the photo diode 72 or the photo diode 73 may be obtained. Thus, a phase difference detecting structure is provided.

FIG. 6 is a diagram illustrating an equivalent circuit in which a photoelectric conversion unit that implements a phase difference detecting circuit includes two photo transistors, according to an embodiment.

Referring to FIG. 6, drain electrodes of photo transistors 45 and 46 are connected to a line 41 having a predetermined electric potential. A gate of the photo transistor 45 receives light. When light is received and photoelectrically converted, electrons move to source electrodes. The source electrodes are connected to a drain electrode of a read-out MOS transistor 47, and a source electrode of the read-out MOS transistor 47 may be connected to an amplification transistor or a reset transistor via a line 44. A gate electrode of the read-out MOS transistor 47 is connected to a read-out timing line 43.

The photo transistor 46 also receives and photoelectrically converts light. Furthermore, a phase difference detecting pixel control line 42 may be connected to a gate electrode of the photo transistor 46. Here, the phase difference detecting pixel control line 42 may be a control line for controlling gate current of the photo transistor 46 and to turn photoelectric conversion output on and off.

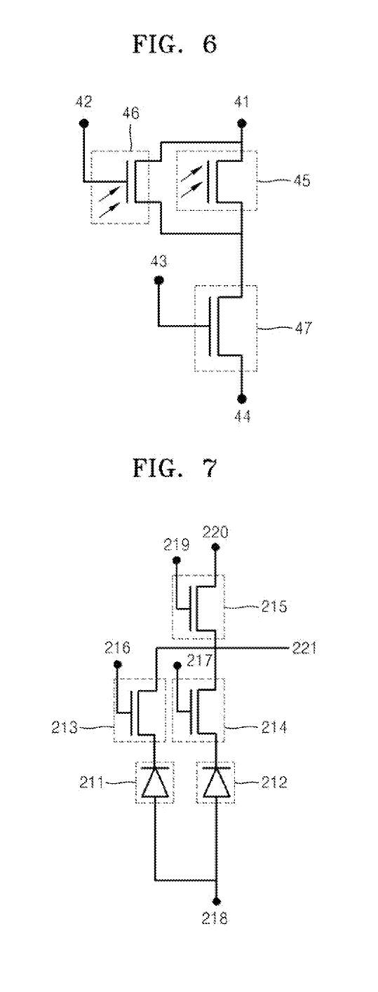

FIG. 7 is a diagram illustrating an equivalent circuit in which a photoelectric conversion unit that implements a phase difference detecting pixel includes two photo diodes according to another embodiment, where each of the two photo diodes includes an independent transmission transistor.

Referring to FIG. 7, read-out transmission transistors 213 and 214 are connected to cathodes of photo diodes 211 and 212, respectively. Furthermore, read-out timing lines 216 and 217 are connected to gate electrodes of the transmission transistors 213 and 214, respectively. A line 218 having a predetermined electric potential is connected to anodes of the photo diodes 211 and 212. Therefore, as transmission transistors 213 and 214 are turned on, electrons of the photo diodes 211 and 212 are output via an output terminal 221. A common reset transistor 215 is connected to outputs of the transmission transistors 213 and 214. The reset transistor 215 has a common electron resetting function. For example, turning on the reset transistor 215 by line 219 can discharge the photo diodes 211 and 212 via line 220.

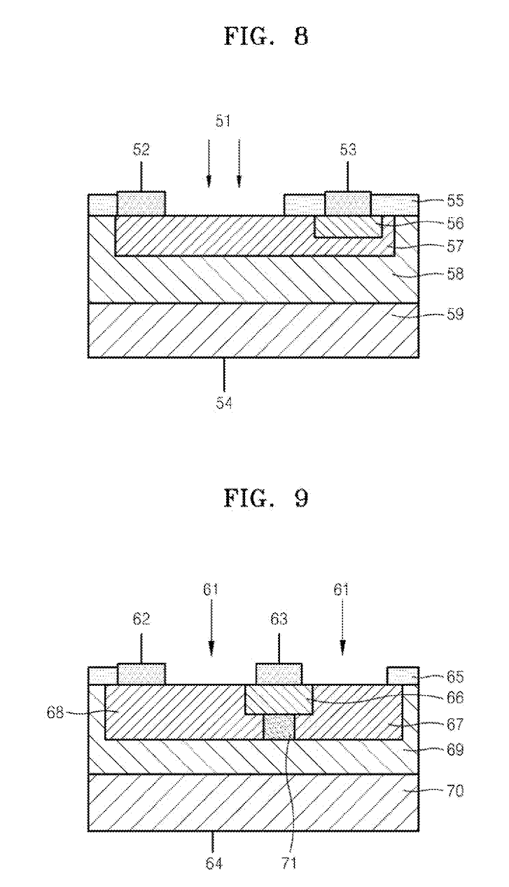

FIG. 8 is a schematic diagram illustrating a photo transistor for controlling a gate of an N-type substrate according to an embodiment.

Referring to FIG. 8, a source layer is formed by arranging a N-type layer 58 on a N-type substrate 59, and a gate layer is formed by arranging a P-type layer 57 thereto. Furthermore, the gate layer has an opening, such that light 51 may be incident via the opening. A drain layer is formed by forming a N-type region 56 in a P-type region 57, and the N-type substrate 59 is connected to a line 54 having a predetermined electric potential. A light blocking layer 55 is arranged to cover the structure except the gate layer including the opening. A photo transistor for controlling a gate of an N-type substrate is formed by connecting a control gate electrode 52 to the gate layer and connecting a drain electrode 53 to the drain layer. The photo transistor for controlling a gate of an N-type substrate as described above may control turning on and off of photoelectric conversion output of a photo transistor by controlling electric potential of the gate electrode 52.

FIG. 9 is a schematic diagram illustrating a photo transistor for controlling a gate of an N-type substrate, according to an embodiment.

Referring to FIG. 9, the photo transistor for controlling a gate of an N-type substrate according to the present embodiment includes a N-type substrate 70, a N-type source layer 69, and P-type gate layers 67 and 68. Each of the gate layers 67 and 68 may have an opening, such that light 61 may be incident via the openings. Furthermore, the photo transistor for controlling a gate of an N-type substrate further includes an N-type drain layer 66, a light blocking layer 65, a line 64 having a predetermined electric potential, a control gate electrode 62, and a drain electrode 63.

Description of the photo transistor for controlling a gate of an N-type substrate shown in FIG. 9 below will describe various differences between the photo transistor for controlling a gate of an N-type substrate shown in FIG. 8 and the photo transistor for controlling a gate of an N-type substrate shown in FIG. 9. First, a first gate layer 67 and a second gate layer 68 are formed by dividing a gate layer including the openings into two portions, and a channel stopper 71 is arranged therebetween. The control gate electrode 62 for controlling turning on and off of photoelectric conversion output of a photo transistor is formed on the second gate layer 68, whereas no electrode is formed on the first gate layer 67. A drain layer 66 functions as a drain layer for both the first gate layer 67 and the second gate layer 68. Therefore, when the light 61 is incident and the control gate electrode 62 is turned on, electrons flowing in both the first gate layer 67 and the second gate layer 68 are output. However, if the control electrode 62 is turned off, only electrons flowing in the first gate layer 67 are output.

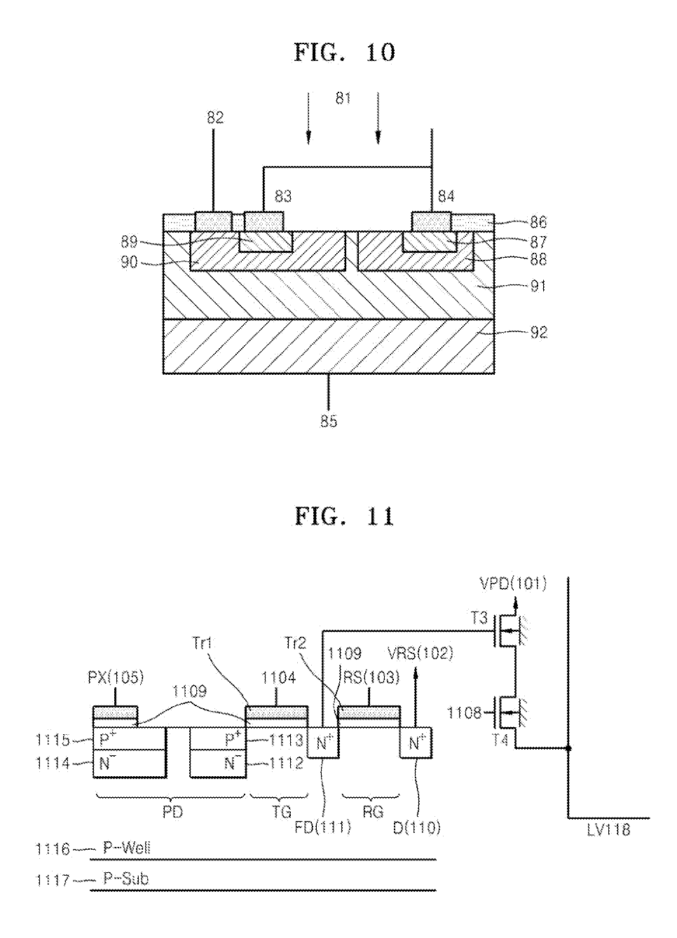

FIG. 10 is a schematic diagram illustrating a photo transistor for controlling a gate of an N-type substrate which implements a plurality of photo transistors, according to an embodiment.

Referring to FIG. 10, the photo transistor for controlling a gate of an N-type substrate includes a N-type substrate 92, a N-type source layer 91, and P-type gate layers 88 and 90. Each of the gate layers 88 and 90 may have an opening, such that light 81 may be incident via the openings. Furthermore, the photo transistor for controlling a gate of an N-type substrate further includes N-type drain layers 87 and 89, a light blocking layer 86, a line 85 having a predetermined electric potential, a control gate electrode 82, and drain electrodes 83 and 84.

Since the photo transistor for controlling a gate of an N-type substrate shown in FIG. 10 is similar to the photo transistor for controlling a gate of an N-type substrate shown in FIG. 9, description of the photo transistor for controlling a gate of an N-type substrate shown in FIG. 10 given below will describe various differences between the photo transistor for controlling a gate of an N-type substrate shown in FIG. 10 and the photo transistor for controlling a gate of an N-type substrate shown in FIG. 9. A plurality of photoelectric conversion units include a plurality of photo transistors from which the gate layers 88 and 90 and the drain layers 87 and 89 are completely separated. Furthermore, outputs of the drain electrodes 83 and 84 are connected and read out at a same time. Here, a separate read-out transistor (not shown) may be arranged. According to an embodiment, the control gate electrode 82 is arranged only at one photo transistor to control electron outputs from a plurality of photo transistors. However, the present embodiment is not limited thereto, and control gate electrodes may be arranged at the both photo transistors and outputs thereof may be selectively switched.

FIG. 11 is a schematic diagram illustrating a pixel which includes a plurality of photoelectric conversion units according to an embodiment, where each of the photoelectric conversion units includes a photo diode including a P-type substrate.

Referring to FIG. 11, two buried photo diodes PD are formed by forming a P-Well layer 1116 at a P-type substrate 1117, burying N-type layers 1112 and 1114, and forming P-type layers 1113 and 1115 thereon. Next, a transmission gate TG including a gate electrode 1104 and an insulation layer 1109 is formed at a region, which is close to the region at which the photo diodes PD are formed, and a N-type floating diffusion layer FS(111) is formed at a region, which is close to the region at which the transmission gate TG is formed. A reset gate RG including a gate electrode RS(103) and the insulation layer 1109 is formed at a region, which is close to the N-type floating diffusion layer FD(111), and a N-type diffusion layer D(110) is formed at a region, which is close to the region at which the reset gate RG is formed. In the buried photo diodes PD, the P-type layers 1113 and 1115 (which may be high concentration P-type layers) may be formed on the N-type layers 1112 and 1114, respectively.

The N-type layers 1112 and 1114, the N-type floating diffusion layer FD(111), and the transmission gate TG implement a MOS transistor Tr1, whereas the N-type floating diffusion layer FD(111), the N-type diffusion layer D(110), and the transmission gate RS(103) implement a MOS transistor Tr2. Next, a gate of a MOS transistor T3 is connected to the N-type floating diffusion layer FD(111). Electrons generated by photo diodes are amplified by the MOS transistor T3 through a voltage potential VPD(101) and, when it is determined by a gate 1108 of MOS transistor T4 to output pixels, the electrons are output via a vertical output line LV 118. In this case, each pixel of an imaging device according to an embodiment may include two photo diodes and four transistors, where a control electrode PX(105) is connected to an end of a photo diode to change electric potential, such that electrons generated by the photo diode are not transmitted to the N-type floating diffusion layer FD(111). By controlling the control electrode PX(105), when a pixel is detecting a phase difference, only electrons generated by one photo diode may be output.

FIG. 12 is a schematic diagram illustrating a circuit of an imaging device (e.g., imaging device 108) capable of focusing via phase difference detection, according to an embodiment, where a pixel 1120 including a plurality of photoelectric conversion units is viewed from above. As shown in FIG. 12, the pixel 1120 includes a micro lens 1127. The pixel 1120 includes photo diodes 1121 and 1122 that are biased in a same direction around the optical axis of the micro lens 1127. Here, based on positions of the imaging device, positional relationships between the optical axis of the micro lens 1127 and the two photo diodes 1121 and 1122 may vary. For example, the positional relationship between the photo diodes 1121 and 1122 relative to the micro lens 1127 may be skewed from a desired positional relationship as a distance of the photo diodes 1121 and 1122 from the optical axis of the micro lens 1127 increases.

The photo diodes 1121 and 1122 include a common read-out unit 1123. Transmission transistors Tr21 and Tr22 are arranged between the photo diodes 1121 and 1122 and the common read-out unit 1123 and connected to a wiring to a transmission signal line T1(126). Here, the photo diodes 1121 and 1122 are arranged, such that openings thereof have a same area. Therefore, although the photo diode 1122 is larger than the photo diode 1121, portions other than the opening is blocked from light, and thus both the photo diode 1121 and the photo diode 1122 are set to a same sensitivity. Next, an electron control unit 1124 is arranged at a light-blocking portion of the photo diode 1122 and a control line PX(125) is connected. If the pixel 1120 is to be used as a phase difference detecting pixel, the electron control unit 1124 may be turned on to prevent generation and output of electrons. If the pixel 1120 is used as an imaging pixel, the electron control unit 1124 may be turned off, such that both the photo diode 1121 and the photo diode 1122 may output electrons.

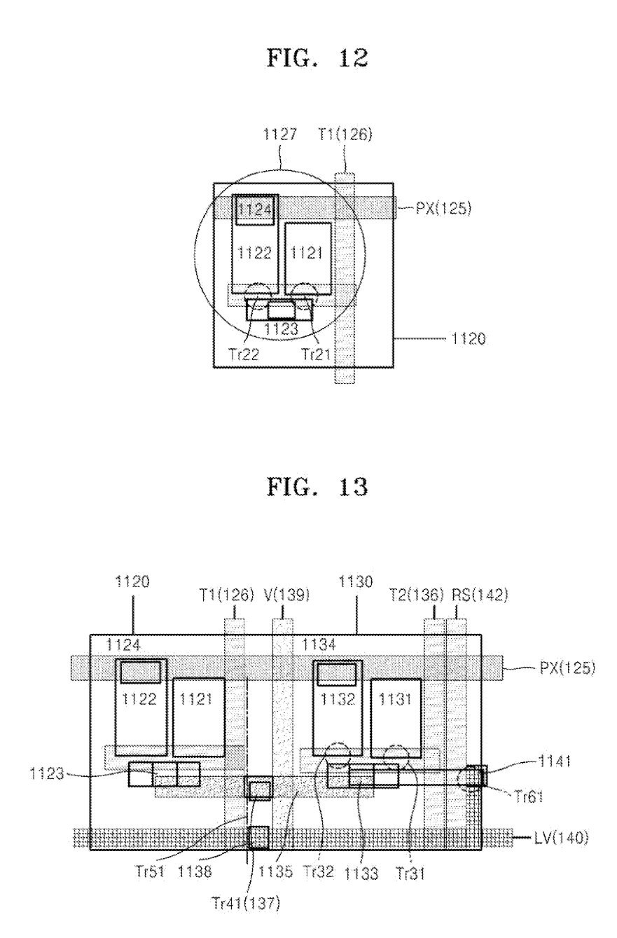

FIG. 13 is a schematic diagram illustrating a circuit of an imaging device capable of focusing via phase difference detection, where two pixels 1120 (as shown in FIGS. 12) and 1130 are connected to each other and an amplification transistor and a reset transistor are shared by the two pixels 1120.

Referring to FIG. 13, like the pixel 1120, the right pixel 1130 includes two photo diodes 1131 and 1132, an electron control unit 1134, a read-out unit 1133, and transmission transistors Tr31 and Tr32. An electron output line 1135 is connected to the read-out unit 1133 of the right pixel 1130 and is connected to an amplification transistor unit Tr41(137) that is shared by the left pixel 1120 and the right pixel 1130. The transmission signal line T1(126) (for pixel 1120) or a transmission signal line T2(136) (for pixel 1130) may be selected and electrons from one of the pixel 1120 or the pixel 1130 are output.

An amplified signal is transmitted from a terminal 1138 of a read-out selecting transistor Tr51 arranged between image signal read-out lines V(139) to an output line LV(140) and is output as a pixel output. Furthermore, at the read-out unit 1133 shared by the left pixel 1120 and the right pixel 1130, a reset transistor Tr61 may be arranged between the terminal 1141 of the output line 1140 and a reset line RS(142), and thus electrons of the two pixels 1120 and 1130 may be simultaneously discharged. If the pixel 1120 and the pixel 1130 are used as phase difference detecting pixels, the electron control unit 1124 and the electron control unit 1134 may be controlled by control signals from the control line PX(125), and thus the pixel 1120 and the pixel 1130 may be simultaneously controlled. Furthermore, an imaging device may perform phase difference detection using 2-dimensonally arranged units, each of which includes the pixel 1120 and the pixel 1130. Although the pixel 1120 and the pixel 1130 are horizontally connected to each other as illustrated, the present disclosure is not limited thereto, and the pixel 1120 and the pixel 1130 may be vertically or diagonally arranged in an imaging device.

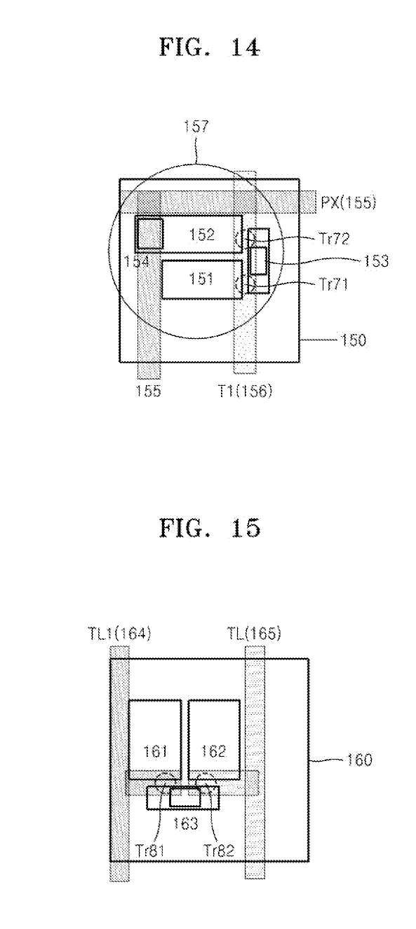

FIG. 14 is a schematic diagram illustrating a circuit of an imaging device capable of focusing via phase difference detection, according to an embodiment.

In FIG. 14, a plurality of photoelectric conversion units are biased in a vertical direction, whereas the plurality of photoelectric conversion units are biased in a horizontal direction in FIG. 12.

Referring to FIG. 14, as in FIG. 12, a pixel 150 includes a micro lens 157 and photo diodes 151 and 152 that are biased around the optical axis of the micro lens 157 in a vertical direction. Furthermore, the pixel 150 includes a read-out unit 153 shared by the photo diodes 151 and 152, electron transmission transistors Tr71 and Tr72 that are arranged between the photo diodes 151 and 152, the read-out unit 153, and a transmission signal line T1(156), an electron control unit 154 arranged at a light blocking layer of the photo diode 152, and control unit control lines PX(155) and 155. According to an embodiment, to use the pixel 150 as a phase difference detecting pixel in a vertical direction, the electron control unit 154 is turned on to prevent or reduce electron generation. Furthermore, if the pixel 150 is used as an imaging pixel, the electron control unit 154 is turned off to output electrons. As a result, both the photo diode 151 and the photo diode 152 generate electrons, thereby outputting a combined electron output. The arrangement of phase difference detecting pixels in a vertical direction as described above allows for detecting focus on an object in which contrasts are distributed in a vertical direction.

FIG. 15 is a schematic diagram illustrating a circuit of an imaging device according to an embodiment.

Referring to FIG. 15, a pixel 160 includes photo diodes 161 and 162 that are arranged around the optical axis of a micro lens (not shown). The pixel 160 includes a common read-out unit 163, a transistor Tr81 that is arranged between the photo diode 161, the read-out unit 163, and a transmission signal line TL1(164), and a transmission transistor Tr82 including the photo diode 162, the read-out unit 163, and the transmission signal line TL(165).

According to an embodiment, when the pixel 160 is used as a phase difference detecting pixel, only electrons from the photo diode 162 may be output by preventing electron output of the photo diode 161 by turning off the transmission signal line TL1(164).

When the pixel 160 is used as an imaging pixel, electrons from both the photo diodes 161 and 162 may be output by turning on the transmission signal line TL1(164). However, the present embodiment is not limited thereto, and a particular photo diode to output electrons may be selected as an occasion demands. Therefore, this embodiment allows for flexibility of configuration of the phase difference detecting pixel.

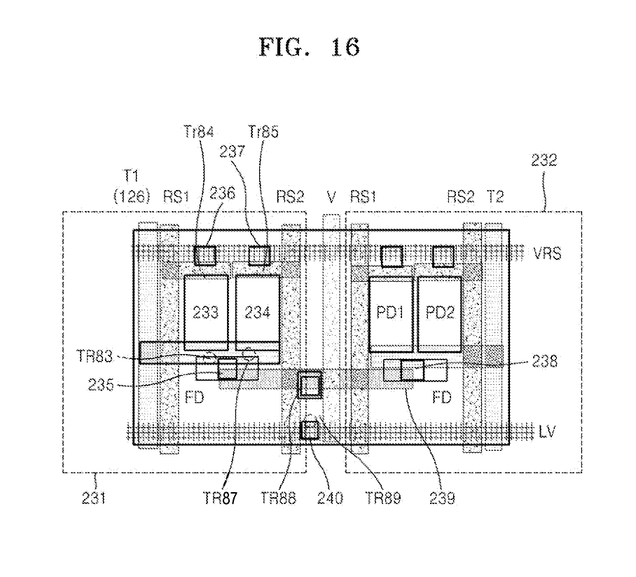

FIG. 16 is a schematic diagram illustrating an imaging device circuit for phase difference AF according to an embodiment. FIG. 16 shows the equivalent circuit shown in FIG. 4 in closer detail.

Referring to FIG. 16, two pixels 231 and 232 including a plurality of photoelectric conversion units are shown from above. Although the pixel 231 includes a micro lens, the micro lens is not shown in FIG. 16 for convenience of explanation. Referring to FIG. 16, the pixel 231 includes photo diodes 233 and 234 that are biased in a same direction around the optical axis of the micro lens. The photo diodes 233 and 234 include a common read-out unit 235, where a transmission transistor TR83 between the photo diodes 233 and 234, the read-out unit 235, and wiring lines of a transmission signal line T1(126). Here, reset units are arranged at an opposite side from the common read-out unit 235 of the photo diodes 233 and 234. As illustrated, reset transistors Tr84 and Tr85 are arranged between the photo diodes 233 and 234, reset terminals 236 and 237, and reset signal lines RS1 and RS2 therebetween. Therefore, during an imaging operation, electron outputs may be prevented by resetting electrons of one of photo diodes 233 or 234 by selectively turning on some of reset transistors Tr84 or Tr85, where the pixel 231 functions as a phase difference detecting pixel. Furthermore, if both the reset transistors are turned on, electrons generated by the photo diodes 233 and 234 are discharged from the reset terminals 236 and 237 via a discharging line VRS without being output to the common read-out unit 235. Furthermore, during an imaging operation, reset transistors are turned off, such that both the photo diodes 233 and 234 output electrons. Both the pixels 231 and 232 have the same configuration, and thus detailed descriptions of the pixel 232 will be omitted.

Furthermore, outputs from the two photo diodes 233 and 234, that is, electron output from the pixel 231 and electron output from the pixel 232 may include the common read-out unit 235 and common read-out unit 238 (for photo diodes PD1 and PD2 of pixel 232) and transmission transistors TR83 and Tr87. An electron output line 239 is connected to electron output units 235 and 238 of the pixels 231 and 232 and is connected to an amplification transistor TR88 shared by the left pixel 231 and the right pixel 232. Outputs of the pixels 231 and 232 are output via one of selected transmission lines T1(126) and T2.

An amplified signal is connected to an output line LV via a terminal 240 of a read-out transistor TR89 arranged between the image signal read-out line V and is output as a pixel output. An imaging device may perform phase difference detection with units, in which the two pixels 231 and 232 are combined with each other, arranged in a 2-dimensional shape. Although the two pixels 231 and 232 are horizontally connected to each other, the present disclosure is not limited thereto, and pixels may be arranged vertically or diagonally in an imaging device.

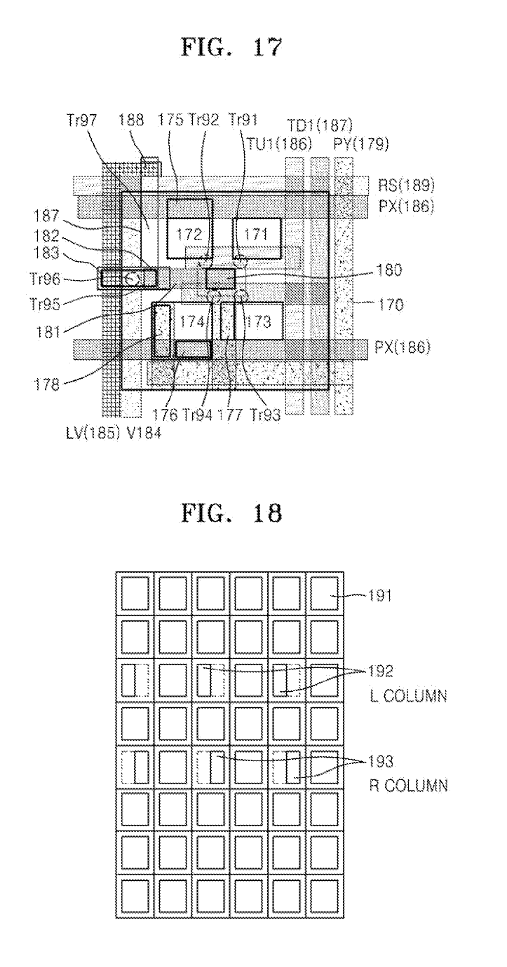

FIG. 17 is a schematic diagram illustrating a circuit of an imaging device capable of focusing via phase difference detection, according to an embodiment.

FIG. 17 shows a pixel in which four photoelectric conversion units are arranged to use both phase difference detecting pixels in a horizontal direction and a vertical direction. The pixel 170 includes photoelectric conversion units 171, 172, 173, and 174 that are arranged around the optical axis of a micro lens (not shown).

The pixel 170 includes: a common read-out unit 180 for the photoelectric conversion units 171, 172, 173, and 174; a transmission transistor Tr91 configured between the common read-out unit 180, the photoelectric conversion unit 171, and a transmission signal line TU1(186); a transmission transistor Tr92 configured between the common read-out unit 180, the photoelectric conversion unit 172, and the transmission signal line TU1(186); a transmission transistor Tr93 configured between the common read-out unit 180, the photoelectric conversion unit 173, and a transmission signal line TD1(187); and a transmission transistor Tr94 configured between the common read-out unit 180, the photoelectric conversion unit 174, and the transmission signal line TD1(187). An output of the phase difference detecting pixel 170 may be output via one of the transmission signal line TU1(186) or the transmission signal line TD1(187).

The common read-out unit 180 is connected to an electron output line 181, wherein a front end of the common read-out unit 180 is connected to a terminal 182 of amplification transistor Tr95. Therefore, an output of a phase difference detecting pixel is amplified by the transmission transistor Tr95. The amplified signal is output from a terminal 183 of a read-out selection transistor Tr96 arranged at a portion of the image signal reading line V184 via an output line LV(185). Furthermore, the terminal 182 of the common electron output line 181 includes a reset transistor Tr97 configured between a terminal 188 of the output line LV(185) and a reset line RS(189). The reset transistor Tr97 may discharge electrons of the four photoelectric conversion units 171, 172, 173, and 174 at once in response to a reset signal.

If it is selected to use the pixel 170 as a phase difference detecting pixel according to an embodiment, the two photoelectric conversion units 172 and 174 may be simultaneously controlled by controlling electron control units 175 and 176 based on a control signal from a phase difference detecting pixel control line PX(186). For example, in case of detecting a horizontal phase difference, the control units 175 and 176 are turned on, such that the pixel 170 functions as a phase difference detecting pixel for detecting a horizontal phase difference. Furthermore, the two photoelectric conversion units 173 and 174 may be simultaneously controlled by controlling the electron control units 177 and 178 based on a control signal from the other phase difference detecting pixel control line PY(179). In this case, in order to detect a vertical phase difference, the control units 177 and 178 may be turned on, such that the pixel 170 functions as a phase difference detecting pixel for detecting a vertical phase difference.

However, the embodiment shown in FIG. 17 is not limited thereto. A phase difference detecting pixel may be controlled by the line PX(186) and the line PY(189) or the line TU1(186) and the line TD1(187). Thus, a R column and a L column may be switched when the pixel 170 is used as a vertical phase difference detecting pixel. Furthermore, if an electron control unit formed of a separate line is added to the photoelectric conversion unit 171, a R column and a L column may be switched when the pixel 170 is used as a horizontal phase difference detecting pixel. Furthermore, in the embodiment shown in FIG. 17, a vertical phase difference detecting pixel may be controlled even if the phase difference detecting pixel control line PY(179) is omitted. In other words, the embodiment shown in FIG. 17 includes all of the embodiments shown in FIGS. 12 through 15, where phase differences may be detected in both a horizontal direction and a vertical direction by limiting electron generation of a photoelectric conversion unit or limiting output of generated electrons. Furthermore, although the four photoelectric conversion units 171, 172, 173, and 174 are arranged as illustrated, the present disclosure is not limited thereto, and one pixel 170 may include more than four photoelectric conversion units.

FIG. 18 is a plan view illustrating an example of phase difference detecting pixel arrangements in an imaging device capable of focusing via phase difference detection.

Referring to FIG. 18, phase difference detecting pixels may be arranged at particular locations of the imaging device in a horizontal direction. For example, a phase difference detecting pixel may be arranged at each R (Red) pixel from four pixels in a RGB Bayer arrangement from other normal imaging pixels 191. Phase difference detecting pixels 192 that implement a phase difference L column and phase difference detecting pixels 193 that implement a phase difference R column may be arranged as shown in FIG. 18. The phase difference detecting pixels 192 and 193 according to an embodiment function to have openings as indicated with a solid line during an focusing operation and function to have normal pixel openings as indicated with a broken line during an imaging operation.

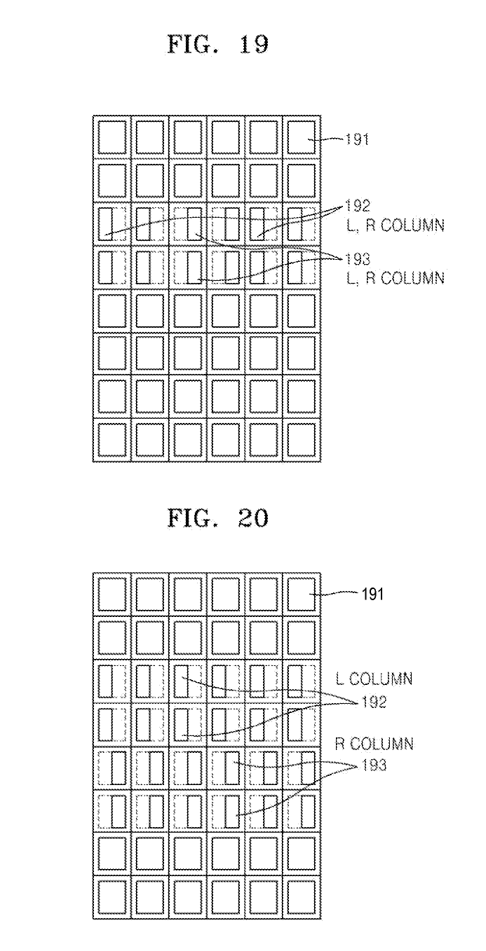

FIG. 19 is a plan view illustrating an example of phase difference detecting pixel arrangements in an imaging device capable of focusing via phase difference detection. Here, it is assumed that pixels are arranged in RGB Bayer arrangement.

Referring to FIG. 19, phase difference detecting pixels may be arranged in a horizontal direction at particular locations of an imaging device in a manner different from that shown in FIG. 18. For example, phase difference detecting pixels may be arranged at each pixel from four pixels of the RGB Bayer arrangement (e.g., red pixel, first green pixel, second green pixel, and blue pixel) between normal imaging pixels 191, where a Y signal is generated by four pixels in case of focusing via phase difference detection as shown in FIG. 19. Furthermore, the phase difference detecting pixel may be alternately handled as a R column or a L column per Y signal. Therefore, a phase difference L column and a phase difference R column may be alternately arranged at a same line per Bayer arrangement. In other words, a L column phase difference detecting pixel 192 and a R column phase difference detecting pixel 193 may be arranged at every four horizontal and vertical pixels. Although the illustrated arrangement is considered to be an arrangement in which defect pixels are conspicuous when pixels of the prior art are employed, phase difference detecting pixels do not become defect pixels according to an embodiment, and thus the arrangement may be employed.

FIG. 20 is a plan view illustrating an example of phase difference detecting pixel arrangements in an imaging device capable of focusing via phase difference detection. Here, it is assumed that pixels are arranged in RGB Bayer arrangement.

Referring to FIG. 20, phase difference detecting pixels may be arranged in a horizontal direction at particular locations of an imaging device in a manner different from that shown in FIG. 19. For example, phase difference detecting pixels may be arranged at all RGB pixels from four pixels of the RGB Bayer arrangement between the normal imaging pixels 191. However, a column generating a Y signal from the four pixels is used as a L column or a R column in case of focusing via phase difference detection. Here, as shown in FIG. 20, phase difference L columns may be successively arranged in a horizontal direction according to the Bayer pattern, whereas phase difference R columns may be successively arranged in a horizontal direction immediately below the phase difference L columns. In other words, according to an embodiment, two columns of the L column phase difference detecting pixels 192 and two columns of the R column phase difference detecting pixels 193 may be arranged for detecting a phase difference.

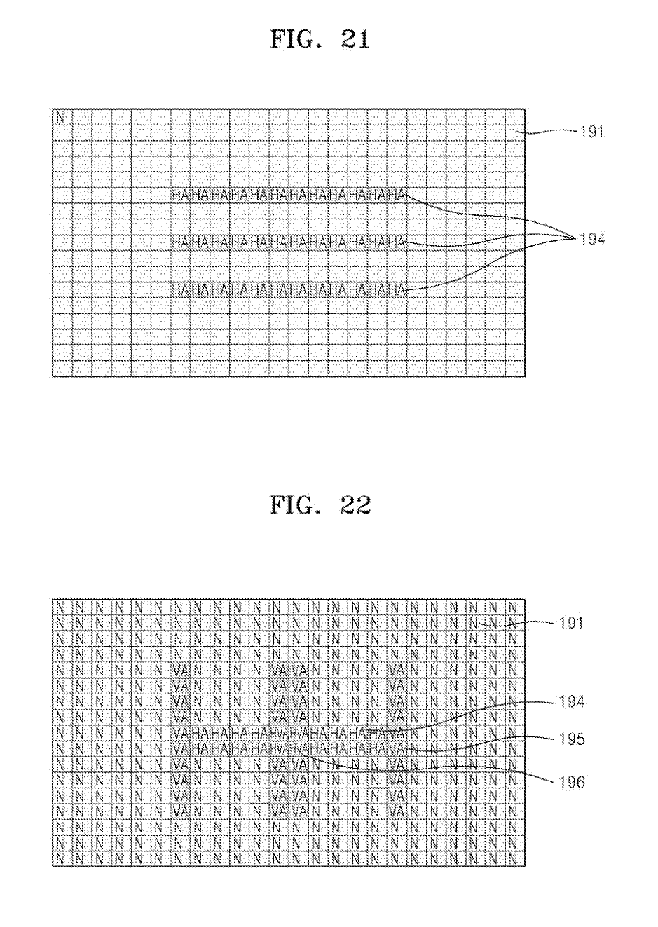

FIG. 21 is a plan view illustrating an entire imaging device capable of focusing via phase difference detection according to an embodiment, showing an example of arrangements of phase difference detecting pixels. However, the number of pixels and arrangement of the pixels are reduced and simplified from those of an actual arrangement.

Referring to FIG. 21, pixels N 191 are normal pixels including one photoelectric conversion unit per pixel. Pixels HA 192 are horizontal phase difference detecting pixels including at least two photoelectric conversion units per pixel, as described above with reference to FIGS. 18 through 20. According to an embodiment, phase difference detecting pixels of an imaging device may be arranged in 3 lines. However, the present disclosure is not limited thereto, and phase difference detecting pixels may be arranged automatically by an imaging apparatus or at necessary locations according to a user input. Furthermore, as described above, the pixels HA 192 function as normal pixels during an imaging operation.

FIG. 22 is a plan view illustrating an entire imaging device capable of detecting not only a horizontal phase difference, but also a vertical phase difference.

Referring to FIG. 22, pixels N 191 are normal pixels each of which includes one photoelectric conversion unit. As described above with reference to FIGS. 18 through 20, pixels HA 194 are horizontal phase difference detecting pixels each of which includes at least two photoelectric conversion units. An imaging device capable of detecting a phase difference may further include vertical phase difference detecting pixels VA 195 for detecting vertical phase difference as described above with reference to FIG. 14. Furthermore, horizontal and vertical phase difference detecting pixels HVA 196 capable of detecting both horizontal and vertical phase differences may be arranged at points where horizontal and vertical phase difference detecting pixels intersect, thereby increasing precision of phase difference focusing of the imaging device.

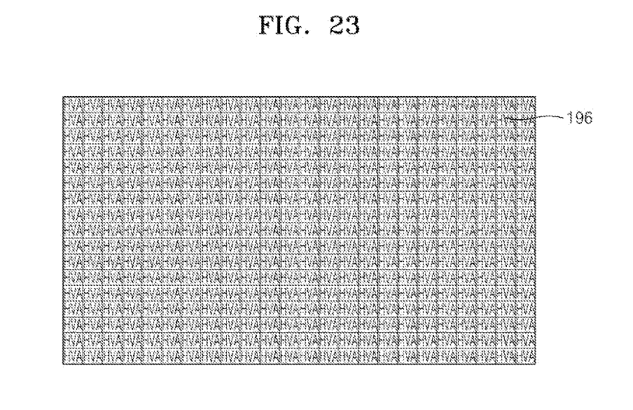

FIG. 23 is a plan view illustrating an entire imaging device according to an embodiment, in which all pixels are capable of detecting horizontal and vertical phase differences.

Referring to FIG. 23, all pixels arranged at the imaging device correspond to the pixel HVA 196 and thus are capable of detecting horizontal and vertical phase differences as described above with reference to FIG. 17. Therefore, a focus may be detected at an arbitrary point in either horizontal or vertical direction.

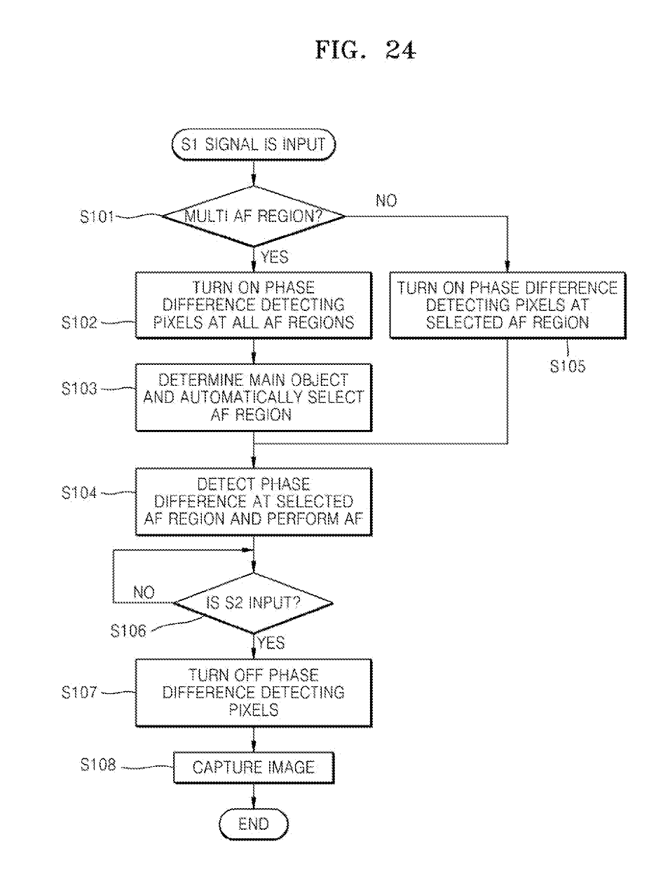

FIG. 24 is a flowchart illustrating a sequence of operating an electronic apparatus (e.g., the electronic apparatus 100) including an imaging device (e.g., the imaging device 108) capable of focusing via phase difference detection according to an embodiment.

Referring to FIG. 24, when an AF start button S1 of the electronic apparatus 100 is pressed (e.g., a half-press of the shutter release button), it is determined whether AF region is selected to multi AF region (operation S101). If the multi AF region is selected, all of phase difference detecting pixels included in the imaging device are switched to phase difference detecting mode, such that the phase difference detecting pixels are arranged in R columns and L columns for phase difference detection (operation S 102). Accordingly, the phase difference detecting pixels are turned on. Since switching of an imaging device to a phase difference detection mode is described above, detailed descriptions thereof will be omitted. Next, a main object is determined by performing focus detections in all AF regions and an AF region for performing AF is automatically selected (operation S103). Next, phase difference detection is performed in the selected AF region and AF is performed based on a result of the phase difference detection (operation S 104). When focusing is completed, the process proceeds to an operation S106.

If the selected AF region is not multi AF region in the operation S101 (e.g., it is selected to perform AF at an AF region selected by a user), the process proceeds to an operation S105. In the operation S 105, phase difference detecting pixels at the selected AF region are turned on to configure R columns and L columns suitable for detecting phase differences at the selected AF region.

Next, in the operation S104, phase difference detection is performed at the selected AF region, and AF is performed based on a result of the phase difference detection. When focusing is completed, the process proceeds to the operation S 106.

In the operation S106, the electronic apparatus 100 waits until a shutter release signal S2 is input (e.g., a fully pressed shutter release button). When the shutter release signal S2 is input, phase difference detecting pixels in the imaging device are switched to an imaging pixel mode. Accordingly, the phase difference detecting pixels are turned off (S108). Since switching of an imaging device to an imaging mode is described above, detailed descriptions thereof will be omitted. When the phase difference detecting pixels are turned off, an image is captured in an operation S108, and thus the sequence is completed.

According to the above embodiments, in an image pixel, phase difference detecting pixels are not defective pixels and may be used as imaging pixels without image quality deterioration in an output image. Furthermore, image quality may not be deteriorated even if the number of phase difference detecting pixels is increased to improve AF efficiency.

All references, including publications, patent applications, and patents, cited herein are hereby incorporated by reference to the same extent as if each reference were individually and specifically indicated to be incorporated by reference and were set forth in its entirety herein.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. An imaging device comprising:
a plurality of pixels that are 2-dimensionally arranged and which receive image light,
wherein at least one pixel of the plurality of pixels comprises:
a micro lens;
a plurality of photoelectric conversion units, which are biased around an optical axis of the micro lens; and
a control unit, which limits generation of electrons photoelectrically converted at at least one photoelectric conversion unit of the plurality of photoelectric conversion units.

2. The imaging device of claim 1, wherein the plurality of photoelectric conversion units comprise a plurality of photo diodes; and
the control unit limits generation of photoelectrically converted electrons by changing an electric potential of at least one photo diode of the plurality of photo diodes.

3. The imaging device of claim 1, wherein the plurality of photoelectric conversion units comprise a plurality of photo transistors; and
the control unit limits generation of photoelectrically converted electrons by changing a gate electric potential of an electron generating unit of at least one photo transistor of the plurality of photo transistors.

4. The imaging device of claim 1, wherein the plurality of photoelectric conversion units comprise a plurality of photo diodes; and
the control unit comprises a reset unit for discharging electrons generated by the plurality of photo diodes and limits generation of photoelectrically converted electrons by discharging electrons generated by at least one photo diode of the plurality of photo diodes.

5. The imaging device of claim 4, wherein the reset unit includes a reset circuit for discharging electrons; and
the reset unit is independent from an output unit.

6. The imaging device of claim 1, wherein at least one pixel, of the plurality pixels, that includes the plurality of photoelectric conversion units is arranged only at a particular region of the imaging device.

7. The imaging device of claim 6, wherein, from the pixels arranged only at the particular region, pixels of which the photoelectric conversion units are biased in a same direction are arranged in the same direction as the direction in which the corresponding photoelectric conversion units are biased.

8. The imaging device of claim 7, wherein pixels of the plurality of pixels that include photoelectric conversion units biased in a horizontal direction are arranged at the imaging device in the horizontal direction.

9. The imaging device of claim 7, wherein pixels of the plurality of pixels that include photoelectric conversion units biased in a vertical direction are arranged at the imaging device in the vertical direction.

10. The imaging device of claim 1, wherein each pixel of the plurality of pixels included in the imaging device comprises a respective plurality of the photoelectric conversion units.

11. The imaging device of claim 10, wherein the plurality of pixels, each of which includes the respective plurality of photoelectric conversion units, comprise the plurality of photoelectric conversion units biased in a horizontal direction and a vertical direction.

12. An imaging device comprising:
a plurality of pixels that are 2-dimensionally arranged and which receive image light,
wherein at least one pixel of the plurality of pixels comprises:
a micro lens;
a plurality of photoelectric conversion units, which are biased around an optical axis of the micro lens; and
a control unit, which selects a first output mode for outputting electrons photoelectrically converted at the plurality of photoelectric conversion units or a second output mode for outputting only electrons photoelectrically converted at one of the plurality of photoelectric conversion units;
wherein generation of electrons photoelectrically converted at at least one photoelectric conversion unit is limited in the second output mode.

13. The imaging device of claim 12, wherein the control units selects the first output mode for an imaging operation; and
the control unit selects the second output mode for a phase difference focusing operation.

14. The imaging device of claim 12, wherein electrons photoelectrically converted at the plurality of photoelectric conversion units are combined and output in the first output mode.

15. The imaging device of claim 12, wherein the at least one pixel further comprises a read-out unit which outputs electrons photoelectrically converted at the plurality of photoelectric conversion units.

16. The imaging device of claim 15, wherein the read-out unit comprises a plurality of read-out transistors for selectively outputting the photoelectrically converted electrons from the plurality of photoelectric conversion units.

17. The imaging device of claim 16, wherein only electrons photoelectrically converted at one photoelectric conversion unit of the plurality of photoelectric conversion units are output by selectively operating the plurality of read-out transistors in the second output mode.

18. The imaging device of claim 12, wherein the at least one pixel that comprises the plurality of photoelectric conversion units is arranged only at a particular region of the imaging device.

19. The imaging device of claim 18, wherein, from the at least one pixel arranged only at the particular region, pixels of which the plurality of photoelectric conversion units are biased in a same direction are arranged in the same direction as the direction in which the corresponding plurality of photoelectric conversion units are biased.

20. The imaging device of claim 19, wherein the at least one pixel that comprises the plurality of photoelectric conversion units is arranged at the imaging device in a horizontal direction and a vertical direction;
wherein the control unit selects the second output mode for the pixels arranged in the horizontal direction when the pixels arranged in the vertical direction correspond to the first output mode; and
wherein the control unit selects the second output mode for the pixels arranged in the vertical direction when the pixels arranged in the horizontal direction correspond to the first output mode.

21. The imaging device of claim 20, wherein pixels at points where the pixels arranged in the horizontal direction and the pixels arranged in the vertical direction intersect comprise a plurality of photoelectric conversion units biased in the horizontal direction and the vertical direction.

22. The imaging device of claim 12, wherein each pixel of the plurality of pixels included in the imaging device comprises the plurality of photoelectric conversion units; and
the plurality of pixels, each of which includes a respective plurality of photoelectric conversion units, comprise the plurality of photoelectric conversion units biased in a horizontal direction and a vertical direction.
